(19) United States
(12) Patent Application Publication
(10) Pub. No.: US 2026/0296143 A1
(43) Pub. Date: Oct. 1, 2026

(54) UNIT COOLER

(71) Applicant: KABUSHIKI KAISHA TOYOTA JIDOSHOKKI, Kariya-shi (JP)

(72) Inventors: Satoru SHIMADA, Kariya-shi (JP); Hisaya KONDO, Kariya-shi (JP); Hiromichi OGAWA, Kariya-shi (JP); Shun KUBOTA, Kariya-shi (JP); Ryota WATANABE, Kariya-shi (JP)

(73) Assignee: KABUSHIKI KAISHA TOYOTA JIDOSHOKKI, Kariya-shi (JP)

(21) Appl. No.: 19/569,305

(22) Filed: Mar. 17, 2026

(30) Foreign Application Priority Data
Mar. 28, 2025 (JP) 2025-057053

(51) Int. Cl. B60H 1/32; B60H 1/00; B66F 9/075

(52) U.S. Cl. CPC B60H 1/3229; B60H 1/00378; B60H 1/3233; B66F 9/07595; B60H 2001/3292

(57) ABSTRACT

A unit cooler includes a housing having an intake port, and a discharge port, an air conditioning unit accommodated in the housing, and a base frame disposed in the housing and on which the air conditioning unit is mounted. The air conditioning unit including an electric compressor, a condenser, an evaporator, a first fan blowing the air toward the condenser, a second fan blowing the air to the evaporator, an inverter driving the electric compressor, and a power conversion device converting electric power to be input to the inverter. The electric compressor, the condenser, the evaporator, the first fan, the second fan, and the inverter are attached to an upper surface of the base frame in a direction of gravity so as to form the refrigeration cycle. The power conversion device is attached to a lower surface of the base frame in the direction of gravity.

### CROSS-REFERENCE TO RELATED APPLICATION

This application claims priority to Japanese Patent Application No. 2025-057053 filed on Mar. 28, 2025, the entire disclosure of which is incorporated herein by reference.

### BACKGROUND ART

The present disclosure relates to a unit cooler.

Japanese Patent Application Publication No. 2024-140629 discloses a conventional unit cooler. The unit cooler is used in industrial vehicles such as a forklift truck having an electric power source.

The unit cooler includes a housing and an air conditioning unit. The housing has an intake port through which air is drawn in and a discharge port through which the air drawn in from the intake port is discharged. The air conditioning unit is accommodated in the housing, forms a refrigeration cycle, cools air drawn in through the intake port, and discharges the cooled air through the discharge port. The air conditioning unit includes an electric compressor, a condenser, a pressure reducing device, and an evaporator. The air conditioning unit also includes a first fan that rotates to blow air to flow through the condenser, and a second fan that rotates to blow air to flow through the evaporator. The electric compressor is disposed between the condenser and the evaporator, the first fan is disposed between the electric compressor and the condenser, and the second fan is disposed between the electric compressor and the evaporator.

The first fan blows air drawn in through the intake port to the condenser, thereby releasing heat from the condenser. The second fan blows air drawn in through the intake port to the evaporator, cools the air by heat absorption by the evaporator, and discharges the cooled air from the discharge port. At this time, a duct, which is provided at the discharge port, allows the air having passed the second fan to be discharged to an outside of the housing toward a driver.

The housing also includes an outer upper cover and an outer under cover. A base plate that has a plate shape and to which the air conditioning unit is attached, and a top plate are disposed between the outer upper cover and the outer under cover. The air conditioning unit, the base plate, and the top plate form an air conditioning module including a piping. The outer upper cover and the outer under cover are fixed together with bolts. When condensate is formed on the evaporator, the condensate drops from the base plate onto the outer under cover and is discharged to the outside from the outer under cover.

In addition, a vibration-damping member is provided between the base plate and the outer under cover. The vibration-damping member includes a first member fastened to the base plate, a second member fastened to the outer under cover, and an intermediate member that connects the first member and the second member and has vibration-damping properties. The outer upper cover and the outer under cover are fixed together with bolts.

This unit cooler suppresses transmission of external vibrations to the air conditioning unit on the base plate with the vibration-damping member, for example, in industrial vehicles that do not have a vibration-reducing means to the same extent as passenger cars. Therefore, in this unit cooler, failures in the air-conditioning unit can be reduced, and vibrations are absorbed by the vibration-damping member, which can contribute to quiet operation.

The industrial vehicles equipped with the unit cooler have various power supply voltages and various required cooling capacities. For this reason, when the electric compressor is driven by an inverter, the air conditioning unit preferably has a power conversion device, such as a DC-DC converter, which converts voltage input to the inverter of the electric compressor.

However, since the power conversion device is inevitably heavy due to the inclusion of magnetic components and the like, if it is directly mounted on the base plate as a part of the air conditioning unit, the center of gravity of the air conditioning module rises, which reduces its vibration resistance.

The present disclosure has been made in view of the above-mentioned conventional circumstances, and is directed to providing a unit cooler that has excellent vibration resistance even when an air conditioning unit includes a power conversion device.

### SUMMARY

In accordance with an aspect of the present disclosure, there is provided a unit cooler including a housing having an intake port through which air is drawn in, and a discharge port through which the air drawn in through the intake port is discharged, an air conditioning unit accommodated in the housing, forming a refrigeration cycle, and configured to cool the air drawn in through the intake port and discharge the cooled air through the discharge port, and a base frame disposed in the housing and on which the air conditioning unit is mounted. The air conditioning unit including an electric compressor, a condenser, an evaporator, a first fan configured to rotate to blow the air toward the condenser, a second fan configured to rotate to blow the air to the evaporator, an inverter configured to drive the electric compressor, and a power conversion device configured to convert electric power to be input to the inverter. The electric compressor, the condenser, the evaporator, the first fan, the second fan, and the inverter are attached to an upper surface of the base frame in a direction of gravity so as to form the refrigeration cycle. The power conversion device is attached to a lower surface of the base frame in the direction of gravity.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view of a forklift truck on which a unit cooler according to an embodiment is mounted;

FIG. 2 is an exploded perspective view of a housing of the unit cooler according to the embodiment;

FIG. 3 is an exploded perspective view of an air conditioning module and surrounding parts of the unit cooler according to the embodiment;

FIG. 4 is a perspective view of the unit cooler according to the embodiment;

FIG. 5 is a cross-sectional view of a vibration-damping member of the unit cooler according to the embodiment;

FIG. 6 is an enlarged cross-sectional view of a base plate, an inner undertray, an outer undertray, and the vibration-damping member of the unit cooler according to the embodiment.

FIG. 7 is a schematic horizontal cross-sectional view of the unit cooler according to the embodiment; and

FIG. 8 is a schematic vertical cross-sectional view of the unit cooler according to the embodiment.

### DETAILED DESCRIPTION OF THE EMBODIMENTS

The following will describe an embodiment of the present disclosure with reference to the accompanying drawings.

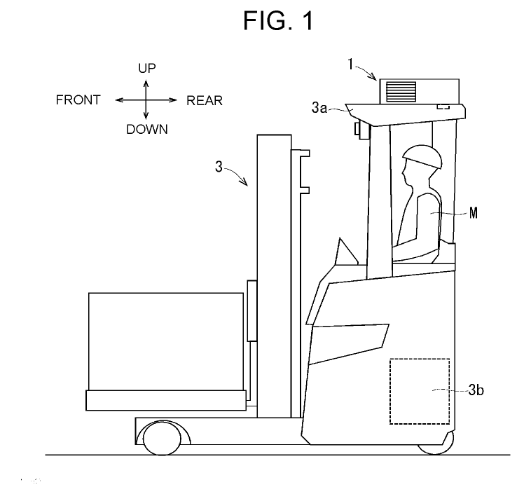

As illustrated in FIG. 1, a unit cooler 1 according to a first embodiment is fixed to a headguard 3a of an electric forklift truck (hereinafter simply referred to as a forklift truck 3). The forklift truck 3 is of a reach type, and an example of an industrial vehicle. In the following, a front-rear direction, an up-down direction, a left-right direction of the forklift truck 3 illustrated in FIG. 1 are used for describing directions of the unit cooler 1. The forklift truck 3 includes a battery 3b as an electric power source, and is operated by an operator M to travel and perform cargo handling operation using electric power supplied from the battery 3b.

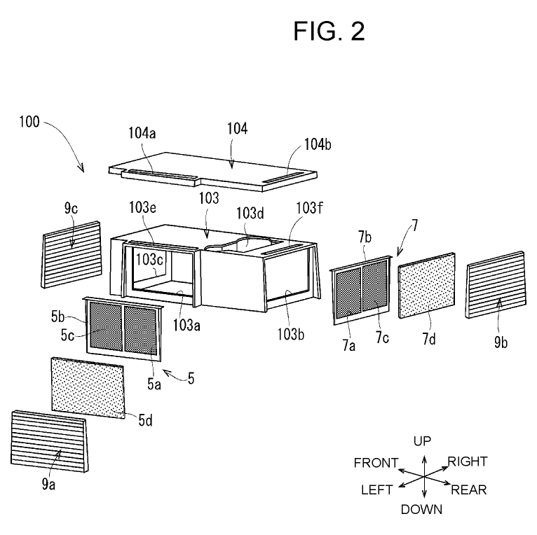

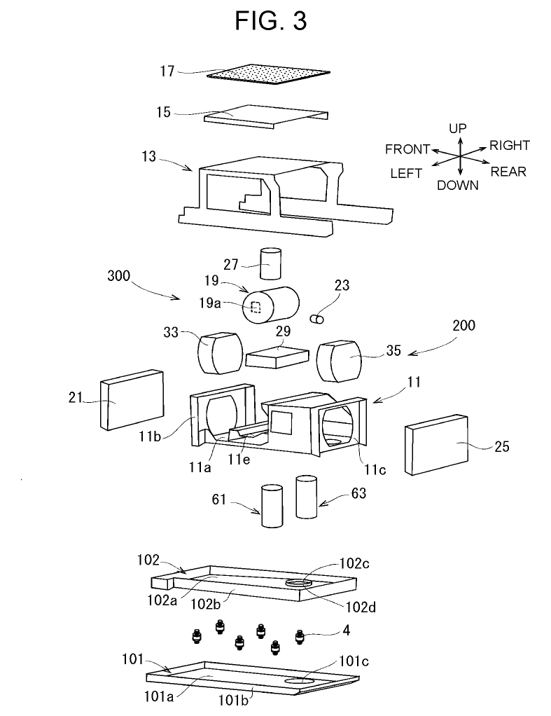

As illustrated in FIGS. 2 and 3, the unit cooler 1 includes a housing 100 and an air conditioning module 300. It is noted that a sealing member and rubber foam are not illustrated in FIGS. 2 and 3.

The housing 100 includes an outer undertray 101, an inner undertray 102, which are illustrated in FIG. 3, an outer upper cover 103, and an outer top cover 104, which are illustrated in FIG. 2. The outer undertray 101 is made of a sheet metal, and the inner undertray 102, the outer upper cover 103, and the outer top cover 104 are made of resin.

As illustrated in FIG. 3, the outer undertray 101 includes a bottom plate 101a having a rectangular plate shape that is long in the front-rear direction, and a peripheral wall 101b protruding upward from a periphery of the bottom plate 101a. Two outlet ports 101c (only one of which is illustrated in FIG. 3) are disposed side by side in the left-right direction and formed through a rear portion of the bottom plate 101a. The bottom plate 101a and the peripheral wall 101b have a plurality of through holes (not illustrated) for mounting the unit cooler 1.

The air conditioning module 300 includes a base frame 11, an upper frame 13, a top frame 15, and an air conditioning unit 200 fixed to these parts and accommodated in the housing 100. The base frame 11, the upper frame 13, and the top frame 15 are made of a sheet metal. A sponge rubber sheet 17 is disposed between the top frame 15 and the outer upper cover 103.

The inner undertray 102 is disposed below the base frame 11. The outer undertray 101 is disposed on a side of the inner undertray 102 opposite from the base frame 11. The inner undertray 102 is disposed between the base frame 11 and the outer undertray 101. Six vibration-damping members 4, extending through the inner undertray 102, are provided between the outer undertray 101 and the base frame 11. As illustrated in FIG. 5, the vibration-damping members 4 each are formed of a first member 51, a second member 52, and an intermediate member 53. The first member 51 includes a disk portion 51a having a disk shape, and an externally threaded screw portion 51b formed integrally with the disk portion 51a and extending from a center of the disk portion 51a in an axial direction, perpendicular to the disk portion 51a. The second member 52 includes a disk portion 52a having a disk shape, and an externally threaded screw portion 52b formed integrally with the disk portion 52a and extending from a center of the disk portion 52a in an axial direction, opposite to the externally threaded screw portion 51b. The intermediate member 53 is made of natural rubber with a Type A durometer hardness of 45, and has vibration-damping and insulating properties. The intermediate member 53 connects the disk portion 51a of the first member 51 and the disk portion 52a of the second member 52.

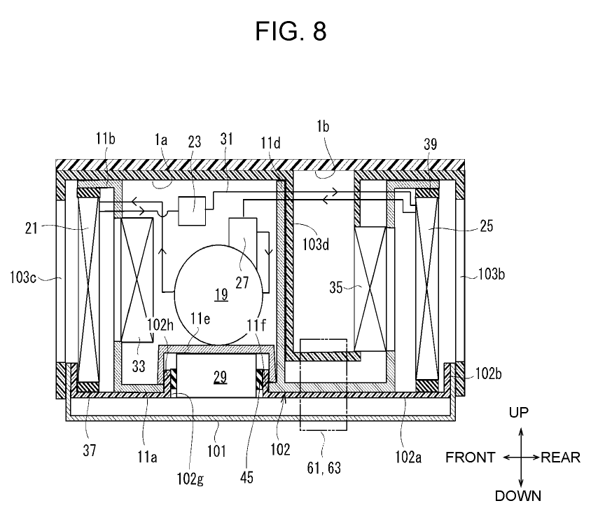

As illustrated in FIG. 3, the inner undertray 102 has a bottom plate 102a having a rectangular plate shape, which is slightly smaller than the bottom plate 101a of the outer undertray 101, and a peripheral wall 102b protruding upward from a periphery of the bottom plate 102a. Outlet ports 102c (only one of which is illustrated in FIG. 3) are formed through a rear portion of the bottom plate 102a so as to be aligned with the outlet ports 101c of the outer undertray 101, respectively. A standing wall 102d protrudes upward from an inner edge of each of the outlet ports 102c. As illustrated in FIG. 8, a through hole 102g is formed through a front portion of the bottom plate 102a, and a partition wall 102h that protrudes upward is formed from an inner edge of the through hole 102g. That is, the inner undertray 102 has the partition wall 102h that defines the through hole 102g. The inner undertray 102 is configured to receive condensate formed on an evaporator 25.

As illustrated in FIG. 2, the outer upper cover 103 has a box shape, which is a rectangular parallelepiped box, extends long in the front-rear direction, and has an opening in a lower end. The outer upper cover 103 has a first intake port 103a formed through a front portion of a left wall, a second intake port 103b formed through a rear wall, and a discharge port 103c formed through a front wall. The first intake port 103a, the second intake port 103b, and the discharge port 103c are located at the same height in the vertical direction. The first intake port 103a and the second intake port 103b are opened so that air is drawn into the housing 100.

The outer upper cover 103 has a duct recess 103d that is recessed downward from an upper wall extending horizontally. Furthermore, a first opening 103e and a second opening 103f are formed through the upper wall of the outer upper cover 103.

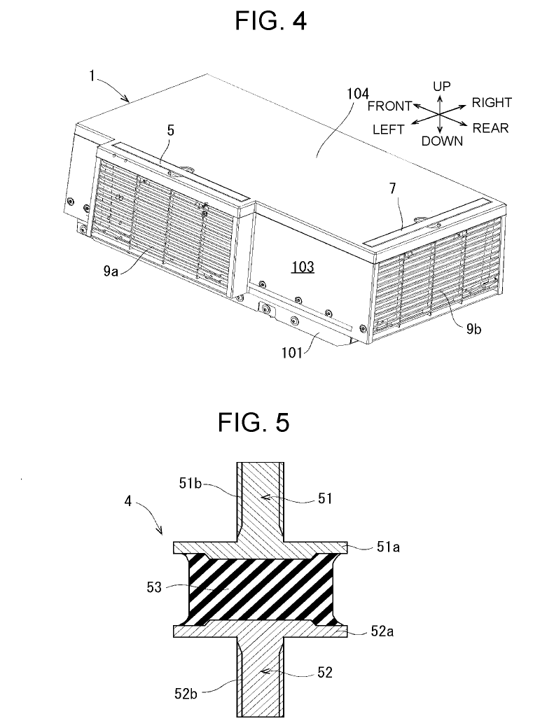

The outer top cover 104 has a plate shape that matches an upper surface of the outer upper cover 103. A sealing member (not illustrated) is disposed between the outer top cover 104 and the duct recess 103d of the outer upper cover 103. As illustrated in FIG. 4, the outer top cover 104 is joined to the outer upper cover 103 to form a main exterior of the unit cooler 1. As illustrated in FIG. 2, the outer top cover 104 has a first opening 104a that aligns with the first opening 103e of the outer upper cover 103 and a second opening 104b that aligns with the second opening 103f of the outer upper cover 103.

A first filter 5 is insertable into and removable from the first openings 104a and 103e from above. A second filter 7 is insertable into and removable from the second openings 104b and 103f from above. The first filter 5 is formed of a frame 5b in which two windows 5a are formed, meshes 5c made of metal and attached to the windows 5a, and a sponge 5d provided on an outer surface of the frame 5b. The second filter 7 is formed of a frame 7b in which two windows 7a are formed, meshes 7c made of metal and attached to the windows 7a, and a sponge 7d provided on an outer surface of the frame 7b.

The sponge 5d and the meshes 5c cover an outer side of the first intake port 103a of the outer upper cover 103 with the first filter 5 inserted into the first opening 104a and the first opening 103e. The sponge 7d and the meshes 7c cover an outer side of the second intake port 103b of the outer upper cover 103 with the second filter 7 inserted into the second opening 104b and the second opening 103f. In addition, a louver 9a is provided at the first intake port 103a so as to be positioned on an outer side of the sponge 5d, and a louver 9b is provided at the second intake port 103b so as to be positioned on an outer side of the sponge 7d. A louver 9c is provided at the discharge port 103c.

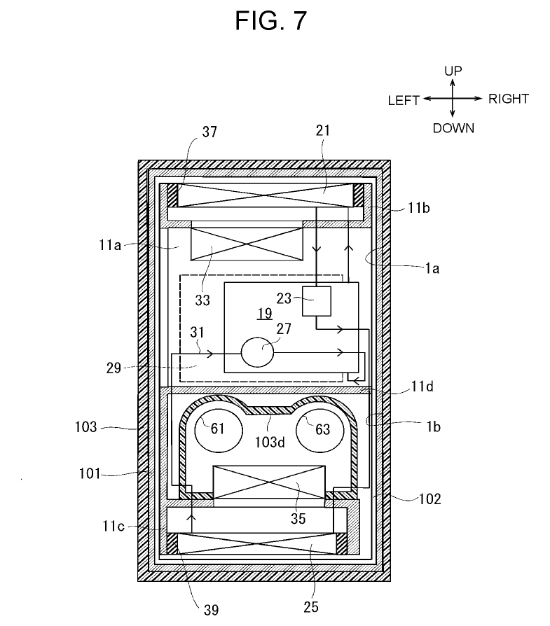

As illustrated in FIG. 3, the base frame 11 is formed by bending and joining a plurality of metal plates. The base frame 11 has a base plate 11a,, which has a rectangular plate shape that is long in the front-rear direction and extends horizontally, a first guide frame 11b fixed to a front end of the base plate 11a, and a second guide frame 11c fixed to a rear end of the base plate 11a. As illustrated in FIG. 7, the base frame 11 also has a partition wall 11d fixed to the center of the base plate 11a. The partition wall 11d divides the base frame 11 into a front portion and a rear portion. The partition wall 11d has a plurality of through holes (not illustrated) for mounting.

Furthermore, as illustrated in FIG. 8, a through hole 11f is formed through the front portion of the base plate 11a. The partition wall 102h of the inner undertray 102 is inserted into the through hole 11f. A bracket 11e having a trapezoid shape is fixed around the through hole 11f. In FIG. 7, the vibration-damping members 4 are not illustrated.

The air conditioning unit 200 includes an electric compressor 19, a condenser 21, an expansion valve 23, the evaporator 25, an accumulator 27, and a control device 29. An inverter 19a that drives the electric compressor 19 is incorporated in the electric compressor 19. That is, the inverter 19a is provided integrally with the electric compressor 19. The inverter 19a may be provided separately from the electric compressor 19. The expansion valve 23 corresponds to a pressure reducing device. The control device 29 incorporates a DC-DC converter that converts voltage to be input to the inverter 19a. The DC-DC converter includes a magnetic member (not illustrated). The DC-DC converter corresponds to a heavy power conversion device. As illustrated in FIG. 7, the electric compressor 19, the condenser 21, the expansion valve 23, the evaporator 25, and the accumulator 27 are connected in this order with a piping 31, and form a refrigeration cycle that circulates refrigerant. The condenser 21 and the evaporator 25 are rectangular parallelepiped bodies of the same shape.

The electric compressor 19, the condenser 21, the expansion valve 23, the evaporator 25, and the accumulator 27 are fixed to an upper surface of the base plate 11a, which is a surface on an upper side in the direction of gravity, and the electric compressor 19 is positioned between the condenser 21 and the evaporator 25. The electric compressor 19 is fixed to an upper surface of the bracket 11e, and the control device 29 is fixed to a lower surface of the bracket 11e, which is a surface on a lower side in the direction of gravity. The partition wall 102h stands upward from the inner undertray 102 so as to surround the control device 29. A vibration absorption material 45 made of rubber foam is disposed between the control device 29 and the partition wall 102h of the inner undertray 102. The condenser 21 is fixed to the first guide frame 11b, and the evaporator 25 is fixed to the second guide frame 11c.

As illustrated in FIG. 3, the air conditioning unit 200 includes a first fan 33 and a second fan 35. The first fan 33 and the second fan 35 each have a built-in motor. As illustrated in FIG. 7, the first fan 33 is disposed between the electric compressor 19 and the condenser 21, and is fixed to the first guide frame 11b. The second fan 35 is provided between the electric compressor 19 and the evaporator 25, and is fixed to the second guide frame 11c.

The first guide frame 11b is provided between the condenser 21 and the first fan 33 so that air blown by the first fan 33 is guided to reach the entire condenser 21. Sealing members 37 to enhance airtightness are provided between the condenser 21 and the first guide frame 11b and between the first fan 33 and the first guide frame 11b.

The second guide frame 11c is also provided between the evaporator 25 and the second fan 35 so that air blown by the second fan 35 is guided to reach the entire evaporator 25. Sealing members 39 to enhance airtightness are also provided between the evaporator 25 and the second guide frame 11c and between the second fan 35 and the second guide frame 11c.

The control device 29 has a power cord (not illustrated) and a connection cord (not illustrated), and the power cord is connected to the battery 3b of the forklift truck 3, and the connection cord is connected to the electric compressor 19, the first fan 33, and the second fan 35. The air conditioning module 300 is formed by fixing the upper frame 13 and the top frame 15 to the base frame 11 on which the air conditioning unit 200 is mounted.

As illustrated in FIGS. 2, 3, and 7, ducts 61, 63 are disposed between the electric compressor 19 and the second fan 35 in the duct recess 103d of the outer upper cover 103 to discharge air having passed through the second fan 35 to an outside of the housing 100. The partition wall 11d of the base frame 11 is positioned between the electric compressor 19 and the ducts 61, 63. The partition wall 11d separates a first fan chamber 1a that is positioned in the front portion of the base frame 11 and into which air is drawn with rotation of the first fan 33 from a second fan chamber 1b that is positioned in the rear portion of the base frame 11 and into which air is drawn with rotation of the second fan 35. The first fan chamber 1a accommodating the electric compressor 19, the inverter 19a, the control device 29, the condenser 21, and the first fan 33, and the second fan chamber 1b accommodating the evaporator 25 and the second fan 35 are defined in the housing 100. The first intake port 103a is in communication with the first fan chamber 1a, and the second intake port 103b is in communication with the second fan chamber 1b.

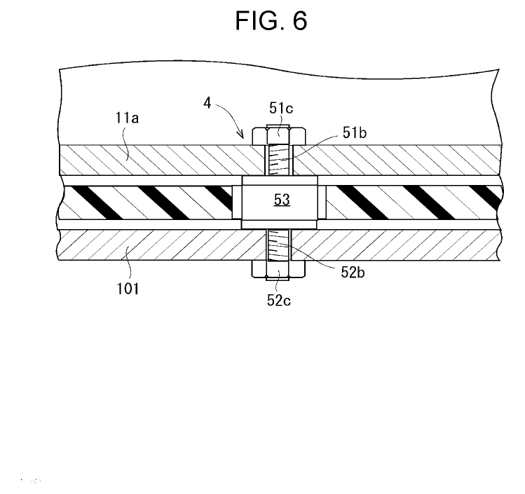

As illustrated in FIG. 6, the first member 51 of each of the vibration-damping members 4 is inserted through the base plate 11a, and a nut 51c is screwed onto the externally threaded screw portion 51b. The second member 52 of each of the vibration-damping members 4 is inserted through the outer undertray 101, and a nut 52c is screwed onto the externally threaded screw portion 52b. In this way, the six vibration-damping members 4 extend through the inner undertray 102 and are provided between the base plate 11a and the outer undertray 101. The vibration-damping members 4 are arranged so that the control device 29 is disposed between the vibration-damping members 4.

In the unit cooler 1, when the operator M turns a switch of the control device 29 on, the electric compressor 19 compresses the refrigerant, and the refrigerant is circulated through the condenser 21, the expansion valve 23, the evaporator 25, and the accumulator 27, to the electric compressor 19. Thus, air drawn in through the second intake port 103b is cooled while flowing through the evaporator 25, and the cool air is supplied to the operator M through the ducts 61, 63. In addition, the condenser 21 condenses the refrigerant using the air drawn in from the first intake port 103a, and releases heat to the discharge port 103c.

In the unit cooler 1, the base frame 11 is disposed in the housing 100, and the air conditioning unit 200 is mounted to the base frame 11. In this case, the electric compressor 19 is disposed between the condenser 21 and the evaporator 25, the first fan 33 is disposed between the electric compressor 19 and the condenser 21, the second fan 35 is disposed between the electric compressor 19 and the evaporator 25, and the expansion valve 23 is disposed between the electric compressor 19 and the condenser 21.

In the unit cooler 1, for example, if a horizontal impact in the left-right direction is applied to the forklift truck 3, which does not have a vibration-reducing means to the same extent as passenger cars, there is a risk that the vibration continues around a middle position of the vibration-damping members 4 disposed three each on the left and right sides. However, in the unit cooler 1, the control device 29 is attached to the base frame 11 on a side thereof opposite side from the electric compressor 19.

More specifically, the base frame 11 has the base plate 11a having a plate shape and the bracket 11e. The electric compressor 19 is attached to the upper surface of the bracket 11e, and the control device 29 is attached to the lower surface of the bracket 11e. Therefore, the center of gravity of the air conditioning module 300 is lower than in a case where the entire air conditioning unit 200 is mounted on the base frame 11, thereby improving vibration resistance. Furthermore, the electric compressor 19 and the control device 29 can be easily provided on opposite sides of the base frame 11.

In addition, in the unit cooler 1, the housing 100 has the first intake port 103a. The first fan 33 blows air drawn in through the first intake port 103a to the condenser 21 to release heat from the condenser 21, and also to the inverter 19a of the electric compressor 19 and the DC-DC converter of the control device 29 to release heat from both of the inverter 19a and the DC-DC converter. This allows heat from the inverter 19a and the DC-DC converter to be reliably released easily, thereby maintaining cooling performance.

In particular, in this unit cooler 1, the partition wall 11d, which separates the first fan chamber 1a from the second fan chamber 1b, is provided in the housing 100, and the first intake port 103a is in communication with the first fan chamber 1a, and the second intake port 103b is in communication with the second fan chamber 1b. Since air drawn into the first fan chamber 1a and air drawn into the second fan chamber 1b are separately introduced, the air having passed through the second fan 35 is more likely to be cooler, thereby discharging more cool air to the driver.

Furthermore, in the unit cooler 1, the inner undertray 102 is disposed in the housing 100, and the inner undertray 102 has the through hole 102g. The control device 29 is disposed so as to extend through the through hole 102g. Therefore, the DC-DC converter of the control device 29 is exposed from the inner undertray 102. This allows heat from the DC-DC converter to be reliably released easily, thereby maintaining cooling performance easily. Furthermore, since the inner undertray 102 is made of resin, the inner undertray 102 is likely to absorb impacts in the horizontal direction, and contributes to reducing the weight of the unit cooler 1.

In addition, in the unit cooler 1, the partition wall 102h is provided in the inner undertray 102, and the vibration absorption material 45 is provided between the control device 29 and the partition wall 102h. The vibration absorption material 45 absorbs vibrations of the DC-DC converter toward the inner undertray 102. This allows the partition wall 102h and the vibration absorption material 45 to prevent the control device 29 from vibrating.

The unit cooler 1 includes the air conditioning unit 200 that has the DC-DC converter, and has excellent vibration resistance. As a result, the unit cooler 1 achieves high durability and quietness.

Although the present disclosure has been described in accordance with the embodiment above, it is not limited to the above-described embodiment, and may be modified within the scope of the disclosure as appropriate.

For example, the unit cooler of the present disclosure may be used in various types of electric forklift trucks such as counter type, picking type, 3-way type, and refrigerator-freezer type electric forklift trucks, and may be used in a wide range of industrial vehicles such as various types of engine forklift trucks, a transport equipment, and a towing vehicle.

This specification also includes the following disclosures.

### Additional note 1

A unit cooler comprising:

a housing having an intake port through which air is drawn in, and a discharge port through which the air drawn in through the intake port is discharged; and

an air conditioning unit accommodated in the housing, forming a refrigeration cycle, and configured to cool the air drawn in through the intake port and discharge the cooled air through the discharge port, wherein

a base frame disposed in the housing and on which the air conditioning unit is mounted,

the air conditioning unit including an electric compressor, a condenser, an evaporator, a first fan configured to rotate to blow the air toward the condenser, a second fan configured to rotate to blow the air to the evaporator, an inverter configured to drive the electric compressor, and a power conversion device configured to convert electric power to be input to the inverter,

the electric compressor, the condenser, the evaporator, the first fan, the second fan, and the inverter are attached to an upper surface of the base frame in a direction of gravity so as to form the refrigeration cycle, and

the power conversion device is attached to a lower surface of the base frame in the direction of gravity.

### Additional note 2

The unit cooler according to Additional note 1, wherein

the base frame includes a base plate having a plate shape, and a bracket fixed to the base plate,

the electric compressor is attached to an upper surface of the bracket in the direction of gravity, and

the power conversion device is attached to a lower surface of the bracket in the direction of gravity.

### Additional note 3

The unit cooler according to Additional note 1 or 2, wherein

the intake port has a first intake port that is opened so that the air is drawn into the housing with rotation of the first fan,

the inverter is attached to the upper surface of the base frame so as to be cooled by the air drawn in through the first intake port, and

the power conversion device is attached to the lower surface of the base frame so as to be cooled by the air drawn in through the first intake port.

### Additional note 4

The unit cooler according to any one of Additional notes 1 to 3, further comprising

an inner undertray disposed below the base plate in the housing and configured to receive condensate formed on the evaporator, wherein

the inner undertray has a through hole through which the power conversion device extends.

### Additional note 5

The unit cooler according to any one of Additional notes 1 to 4, wherein

the inner undertray has a partition wall standing upward so as to surround the power conversion device, the partition wall defining the through hole,

a vibration absorption material is disposed between the power conversion device and the partition wall, the vibration absorption material being made of rubber foam and absorbing vibrations of the power conversion device toward the inner undertray.

### Additional note 6

The unit cooler according to any one of Additional notes 1 to 5,

the housing includes an outer undertray disposed on a side of the base plate opposite from the inner undertray,

a plurality of vibration-damping members is disposed between the outer undertray and the base plate, the plurality of vibration-damping members extending through the inner undertray,

the plurality of vibration-damping members is arranged so that the power conversion device is disposed between the vibration-damping members.

### Additional note 7

The unit cooler according to any one of Additional notes 1 to 6, wherein

the power conversion device includes a magnetic member.

### Additional note 8

The unit cooler according to any one of Additional notes 1 to 7, wherein

a first fan chamber in which the electric compressor, the inverter, the power conversion device, the condenser, and the first fan are accommodated is defined in the housing, and

a second fan chamber in which the evaporator and the second fan are accommodated is defined in the housing,

the first fan chamber and the second fan chamber are partitioned by the partition wall,

the intake port has a second intake port that is opened so that the air is drawn into the housing with rotation of the second fan, and the air drawn in through the second intake port is cooled while flowing through the evaporator.

### Industrial Applicability

The present disclosure can be used for a unit air conditioner that can be installed as an option in an industrial vehicle.

What is claimed is:

1. A unit cooler comprising:
a housing having an intake port through which air is drawn in, and a discharge port through which the air drawn in through the intake port is discharged;
an air conditioning unit accommodated in the housing, forming a refrigeration cycle, and configured to cool the air drawn in through the intake port and discharge the cooled air through the discharge port; and
a base frame disposed in the housing and on which the air conditioning unit is mounted,
the air conditioning unit including an electric compressor, a condenser, an evaporator, a first fan configured to rotate to blow the air to flow through the condenser, a second fan configured to rotate to blow the air to flow through the evaporator, an inverter configured to drive the electric compressor, and a power conversion device configured to convert electric power to be input to the inverter, wherein
the electric compressor, the condenser, the evaporator, the first fan, the second fan, and the inverter are attached to an upper surface of the base frame in a direction of gravity so as to form the refrigeration cycle, and
the power conversion device is attached to a lower surface of the base frame in the direction of gravity.

2. The unit cooler according to claim 1, wherein
the base frame includes a base plate having a plate shape, and a bracket fixed to the base plate,
the electric compressor is attached to an upper surface of the bracket in the direction of gravity, and
the power conversion device is attached to a lower surface of the bracket in the direction of gravity.

3. The unit cooler according to claim 1, wherein
the intake port has a first intake port that is opened so that the air is drawn into the housing with rotation of the first fan,
the inverter is attached to the upper surface of the base frame so as to be cooled by the air drawn in through the first intake port, and
the power conversion device is attached to the lower surface of the base frame so as to be cooled by the air drawn in through the first intake port.

4. The unit cooler according to claim 1, further comprising
an inner undertray disposed below the base plate in the housing and configured to receive condensate formed on the evaporator, wherein
the inner undertray has a through hole through which the power conversion device extends.

5. The unit cooler according to claim 4, wherein
the inner undertray has a partition wall standing upward so as to surround the power conversion device, the partition wall defining the through hole, and
a vibration absorption material is disposed between the power conversion device and the partition wall, the vibration absorption material being made of rubber foam and absorbing vibrations of the power conversion device toward the inner undertray.

6. The unit cooler according to claim 4, wherein
the housing includes an outer undertray disposed on a side of the base plate opposite from the inner undertray,
a plurality of vibration-damping members is disposed between the outer undertray and the base plate, the plurality of vibration-damping members extending through the inner undertray, and
the plurality of vibration-damping members is arranged so that the power conversion device is disposed between the vibration-damping members.

7. The unit cooler according to claim 1, wherein
the power conversion device includes a magnetic member.

8. The unit cooler according to claim 3, wherein
a first fan chamber in which the electric compressor, the inverter, the power conversion device, the condenser, and the first fan are accommodated is defined in the housing,
a second fan chamber in which the evaporator and the second fan are accommodated is defined in the housing,
the first fan chamber and the second fan chamber are partitioned by the partition wall, and
the intake port has a second intake port that is opened so that the air is drawn into the housing with rotation of the second fan, and the air drawn in through the second intake port is cooled while flowing through the evaporator.
